(19) United States
(12) Patent Application Publication
(10) Pub. No.: US 2019/0087174 A1
(43) Pub. Date: Mar. 21, 2019

(54) BACKGROUND FIRMWARE UPDATE

(71) Applicant: Western Digital Technologies, Inc., San Jose, CA (US)

(72) Inventors: Cory LAPPI, Rochester, MN (US); William Jared WALKER, Rochester, MN (US); Xin CHEN, Rochester, MN (US)

(21) Appl. No.: 16/134,910

(22) Filed: Sep. 18, 2018

Related U.S. Application Data
(60) Provisional application No. 62/561,611, filed on Sep. 21, 2017.

(51) Int. Cl. G06F 8/654

(52) U.S. Cl. CPC G06F 8/654; G06F 9/4401

(57) ABSTRACT

The present disclosure generally relates to caching a new firmware download in a wear-leveled location that can accommodate more than several hundred downloads.

### CROSS-REFERENCE TO RELATED APPLICATIONS

The present application claims priority to U.S. Provisional Application 62/561,611 filed Sep. 21, 2017, the entirety of which is incorporated by reference.

### BACKGROUND OF THE DISCLOSURE

### Field of the Disclosure

Embodiments of the present disclosure generally relate to a storage device and a method of operating the storage device. More specifically, embodiments of the present disclosure provide methods and apparatus to perform background firmware updates.

### Description of the Related Art

Firmware is provided with computer apparatus to allow the apparatus to perform desired functions. The computer apparatus, as it ages, may be required to perform tasks that are different than what was originally intended, or the original firmware may have not been written free from errors. As either of these situations can arise, from time to time, firmware needs to be updated. Firmware updates to storage devices can be challenging as extreme care must be exercised in not only the writing of the firmware, but also the correct implementation of the firmware for apparatus that may be operating around the globe.

When firmware updates need to be downloaded to the device, the downloads are typically either power-safe with a long response time or quick without being power-safe. Power-safe is understood to be safe in the event of a power loss, wherein the device is not compromised with potentially corrupted firmware, making the device unusable. More data and code is used to run the storage devices (e.g., SSD devices), but to have more data and code, more download time is typically needed.

In other conventional methods, power-safe approaches to loading firmware included writing the firmware package to a fast form of non-volatile media (i.e., non-wear leveled single level cell (“SLC”) NAND). One drawback of this approach, however, is that the lifetime product downloads are limited to only a few hundred downloads due to low NAND endurance. The use of a non-wear-leveled (“SLC”) NAND location for the new firmware also results in added complexity in the firmware to manage read disturb effects, resulting in additional hits to NAND endurance in those slots and possible offline firmware degradation over time. The SLC NAND locations are also more expensive than multi-level cell (“MLC”) or triple level cell (“TLC”).

There is a need to have a power-safe download that can be stored in memory that can endure more than several hundred downloads.

There is a further need to provide for power-safe download capacity that is economical for both the user and the manufacturer.

### SUMMARY OF THE DISCLOSURE

The present disclosure generally relates to caching a new firmware download in a wear-leveled location that can accommodate more than several hundred downloads.

In one non-limiting embodiment, a method of performing a background firmware update, comprising: booting a device with an original firmware from a first non-volatile memory boot portion, downloading a firmware update during the booting of the device from the non-volatile memory, transmitting the firmware update from the non-volatile memory to the non-volatile memory boot portion so that a successive booting of the device will use the firmware update and erasing the original firmware from the non-volatile memory boot portion.

In another non-limiting embodiment, an apparatus is disclosed comprising means for booting a device with an original firmware from a first non-volatile memory boot portion, means for downloading a firmware update during the booting of the device from the non-volatile memory and means for transmitting the firmware update from the non-volatile memory to the non-volatile memory boot portion so that a successive booting of the device will use the firmware update.

In another non-limiting embodiment, a method of performing a background firmware update for a solid state device is disclosed comprising: performing a power on procedure for the solid state device, booting the solid state device with an original firmware from a first non-volatile memory boot portion, checking for a firmware update in a second non-volatile memory, downloading a firmware update from the second non-volatile memory, through an interface, during the booting of the solid state device from the non-volatile memory when the checking for the firmware update indicates a presence of the firmware update; transmitting the firmware update from the second non-volatile memory to the first non-volatile memory boot portion so that a successive booting of the device will use the firmware update and erasing the original firmware from the non-volatile memory boot portion.

In another non-limiting embodiment, an apparatus for performing a background firmware update is disclosed comprising: means for performing a power on procedure for the solid state device; means for booting the solid state device with an original firmware from a first non-volatile memory boot portion, means for checking for a firmware update in a second non-volatile memory, means for downloading a firmware update from the second non-volatile memory, through an interface, during the booting of the solid state device from the non-volatile memory when the checking for the firmware update indicates a presence of the firmware update, means for transmitting the firmware update from the second non-volatile memory to the first non-volatile memory boot portion so that a successive booting of the device will use the firmware update and means for erasing the original firmware from the non-volatile memory boot portion.

In another non-limiting embodiment, an apparatus is disclosed comprising: a first non-volatile memory, a second non-volatile memory, an interface configured transmit and receive data from the apparatus and a controller configured to download a firmware update through the interface to the second non-volatile memory, wherein the controller is further configured to copy the firmware from the second non-volatile memory to the first non-volatile memory in a background environment.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic illustration of device according to one embodiment.

FIG. 2 is a schematic illustration of a method to power-safe boot a storage device using wear-leveled memory according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relates to caching a new firmware download in a wear-leveled location that can accommodate more than several hundred downloads.

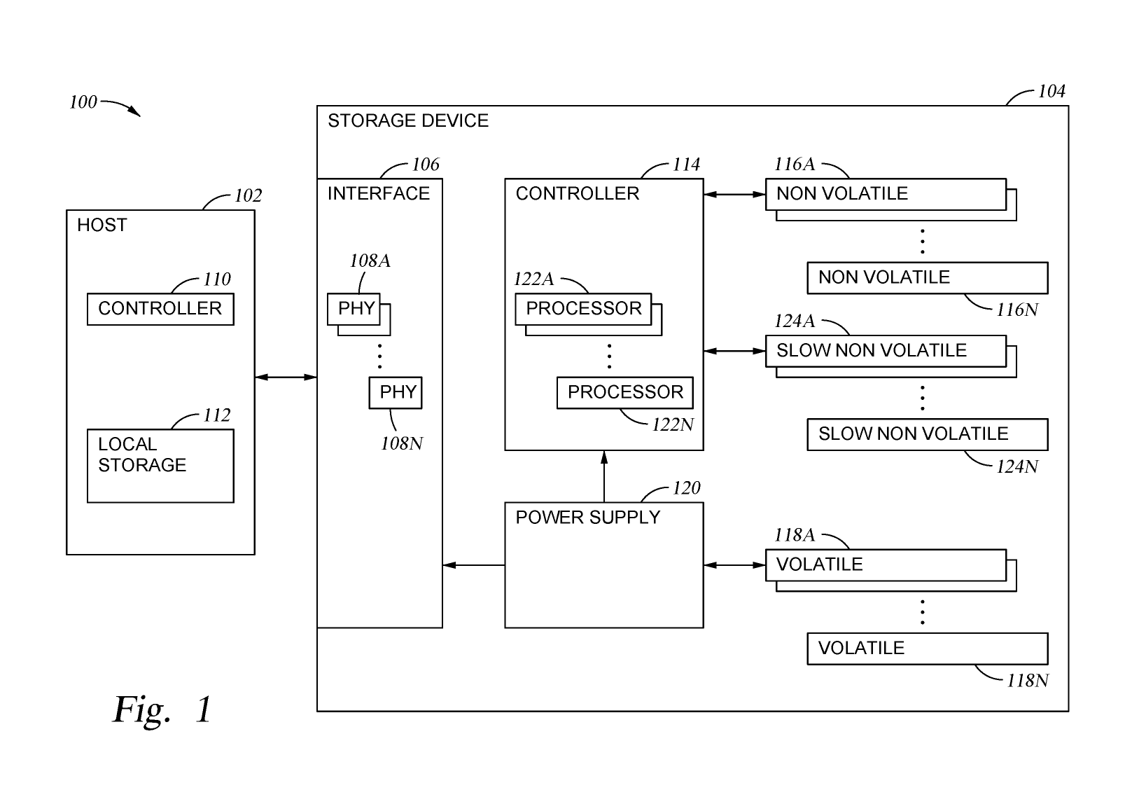

FIG. 1 is a schematic illustration of device 100 according to one embodiment. The device includes a host device 102 and a storage device 104. The host device 102 is coupled to the storage device 104 both physically as well as electronically through an interface 106 that contains one or more phys 108A-108N. In other embodiments, the device 100 may be connected only from a data transfer capability so that data may be sent from the host device 102 to the storage device 104 and vice versa.

The host device 102 includes a controller 110 as well as a local storage device 112 such as an internal memory. The storage device 104 also includes a controller 114 that is coupled to and communicates with the interface 106 as well as both the one or more fast or quick non-volatile memory devices 116A-116N and the one or more volatile memory devices 118A-118N. Details of the controller 114 will be described later.

In embodiments, a power supply 120 is provided. In at least one embodiment, the power supply 120 is coupled to the interface 106 and controller 114. The controller 114 includes one or more processors 122A-122N. Additionally, the controller 114 is coupled to one or more slow non-volatile memory devices 124A-124N. An example of a slow non-volatile memory device 124A-124N is NOR and an example of fast or quick non-volatile memory devices 116A-116N is NAND. As will be understood, when described as a non-volatile memory device, the device may be a stand-alone unit, a chip, a card or other form factor as necessary.

In some examples, the storage device 104 may include additional components not shown in FIG. 1 for sake of clarity. For example, the storage device 104 may include a printed board (PB) to which components of the storage device 104 are mechanically attached and which includes electrically conductive traces that electrically interconnect components of storage device 104, or the like. In some examples, the physical dimensions and connector configurations of the storage device 104 may conform to one or more standard form factors. Some example standard form factors include, but are not limited to, 3.5″ hard disk drive (HDD), 2.5″ HDD, 1.8″ HDD, peripheral component interconnect (PCI), PCI-extended (PCI-X), PCI Express (PCIe) (e.g., PCIe x1, x4, x8, x16, PCIe Mini Card, MiniPCI, etc.). In some examples, storage device 104 may be directly coupled (e.g., directly soldered) to a motherboard of the host device 102.

The interface 106 may operate in accordance with any suitable protocol. For example, the interface 106 may operate in accordance with one or more of the following protocols: advanced technology attachment (ATA) (e.g., serial-ATA (SATA) and parallel-ATA (PATA)), Fibre Channel, small computer system interface (SCSI), serially attached SCSI (SAS), peripheral component interconnect (PCI), PCI-express, or Non-Volatile Memory Express (NVMe). The electrical connection of the interface 106 (e.g., the data bus, the control bus, or both) is electrically connected to the controller 114, providing electrical connection between the host device 102 and the controller 114, allowing data to be exchanged between host device the 102 and the controller 114. In some examples, the electrical connection of the interface 106 may also permit the storage device 104 to receive power from the host device 102. For example, as illustrated in FIG. 1, the power supply 120 may receive power from host device the 102 via the interface 106.

The storage device 104 may include the power supply 120, which may provide power to one or more components of the storage device 104. When operating in a standard mode, the power supply 120 may provide power to the one or more components using power provided by an external device, such as the host device 102. For instance, the power supply 120 may provide power to the one or more components using power received from the host device 102 via the interface 106. In some examples, the power supply 120 may include one or more power storage components configured to provide power to the one or more components when operating in a shutdown mode, such as where power ceases to be received from the external device. In this way, the power supply 120 may function as an onboard backup power source. Some examples of the one or more power storage components include, but are not limited to, capacitors, super capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases. Use of items, such as super capacitors, may be performed in instances that environmental conditions warrant such use.

The storage device 104 includes one or more volatile memory devices 118A-118N, which may be used by the controller 114 to temporarily store information. In some examples, the controller 114 may use the one or more volatile memory devices 118A-118N as a cache. Volatile memory devices are defined herein as a device wherein data is lost when power is removed or cut off from the device. For instance, the controller 114 may store cached information in the one or more volatile memory devices 118A-118N until the cached information is written to the one or more non-volatile memory devices 116A-116N. The one or more volatile memory devices 118A-118N may consume power received from the power supply 120 to maintain the data stored in the one or more volatile memory devices 118A-118N. Examples of volatile memory include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, and the like)).

The storage device 104 includes the controller 114, which may manage one or more operations of the storage device 104. For instance, the controller 114 may manage the reading of data from and/or the writing of data to one or more non-volatile memory devices 116A-116N or one or more volatile memory devices 118A-118N. In some examples, the controller 114 may manage the reading of data from and/or the writing of data to the one or more non-volatile memory devices 116A-116N or one or more volatile memory devices 118A-118N by exchanging signals with the one or more non-volatile memory devices 116A-116N or the one or more volatile memory devices 118A-118N. As discussed above, the controller 114 may exchange signals with the one or more non-volatile memory devices 116A-116N or the one or more volatile memory devices 118A-118N in accordance with a communication protocol.

The controller 114 includes one or more processors 122A-122N. The processors 122A-122N may be configured to execute tasks. The tasks may be of different types, and, in some examples, each respective type of task may be stored in or associated with a respective task queue while waiting for execution by the processor 122A-122N. The different types of tasks may include, for example, front end tasks, which may include receiving and interpreting instructions received from the host device 102. Other types of tasks including caching; back-end tasks, which may include reading data from or writing data to non-volatile memory 116; housing-keeping, which may include garbage collection, wear leveling, TRIM, or the like; and system tasks. In some examples, the processor 122A-122N may be referred to as a computer unit, a processing unit, a core, or a central processing unit (CPU).

As will be discussed in greater detail below, caching the downloaded firmware package in a wear-leveled location on a customer-spaced reserved area in NAND allows for lower cost and higher endurance. After the download of the firmware to NAND, the cached firmware can then be synced to NOR in the background after the download status has been returned to the host device 102. The customer-space reserved area is a place capable of a multitude of downloads (i.e., 30 k downloads or more). One example of a customer-space reserved area is general media or any general memory that is quick to access such as phase change memory (PCM) or a hard disk drive (HDD). In embodiments, the customer-space reserved area is boot accessible media and is an area that can be written to fast. The customer-space reserved area, furthermore, is a memory that does not immediately start on boot-up of a host device. Any boot process occurring prior to completion of a sync to NOR will perform a dual boot process where the original firmware will boot and find the more current firmware cached on the NAND (or customer-space reserved area) and wherein the device loads and boots the cached firmware. The sync from the NAND to NOR occurs in the background, therefore minimizing demands on the processor and data bus. Once the firmware sync is complete, the copy of the firmware on the NAND (or customer-space reserved area) is deleted and dual booting is no longer necessary. Thus, the speed of NAND is possible with the endurance of NOR. The background syncing is done by reading portions of the firmware (“chunks”) from the NAND copy to write to the NOR and writing those chunks as host input/output (“I/O”) idle time allows. A quality of service (“QoS”) mechanism can be used to ensure the firmware background syncing will complete within a certain among of time regardless of host I/O.

The advantages of the disclosure includes providing the storage device with the endurance of NOR for product or firmware downloads, the speed of NAND for overall download times, and lower product cost for dedicated SLC NAND areas. Furthermore, the method provided allows for power safe operations, providing more reliability for the end user.

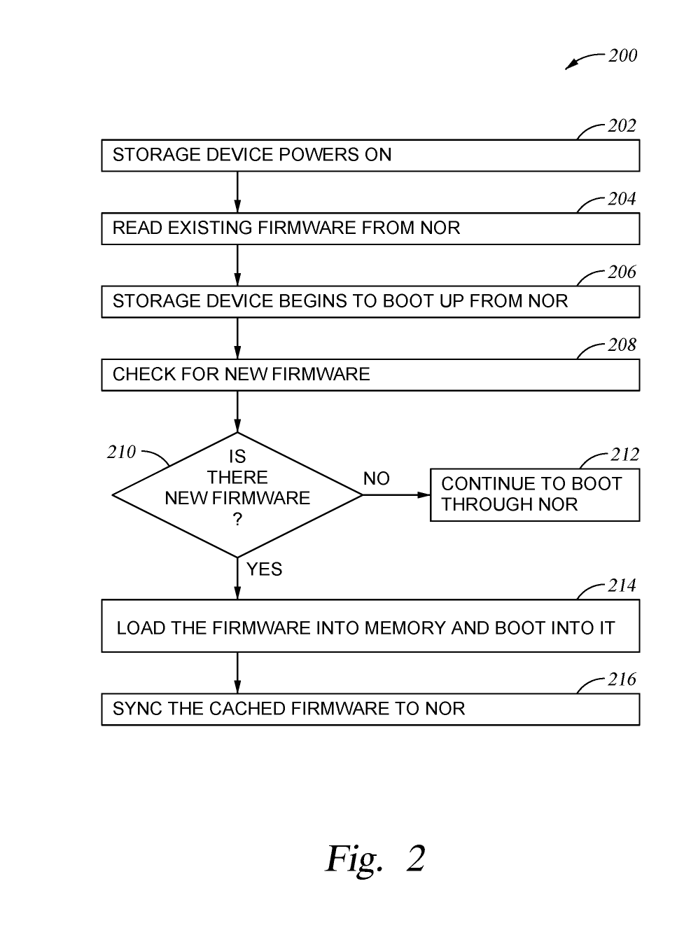

FIG. 2 is a schematic illustration of a method 200 to power-safe boot a storage device using wear-leveled memory according to one non-limiting embodiment. The method starts at item 202 where the storage device 104 begins a power on procedure. Thereafter, the controller 114 reads the existing firmware which resides in the slow non-volatile memory such as a NOR storage device in item 204. The storage device 104 begins to boot up with the firmware stored on the NOR storage device in item 206. While the storage device is booting up, the controller 114 checks other storage devices to see if there is new firmware in item 208. If there is no firmware in item 210, then the boot up continues through NOR in item 212. If, however, there is firmware that is detected, then the new firmware is loaded into memory and booted into at 214. Once the dual boot into the latest firmware is complete, the background synchronization of the latest firmware to the NOR can proceed as described below. Then, in item 216, the new firmware is written to NOR so that subsequent boot-ups will occur through NOR. The writing of the new firmware in 216 occurs in the background, thereby minimally affecting processor function and bus function. If there is a power loss during item 216, the new firmware would still be in cache and thus, the process beginning at item 202 would be able to proceed normally and thus, the process is power-safe. Once new firmware is written to NOR, the copy in the NAND may be deleted once synchronization is complete.

By using a wear-leveled location on customer-space reserved area storage devices, the storage device can process thousands of firmware updates without failure. Additionally, the firmware update is both power-safe and faster than directly writing to NOR.

In one non-limiting embodiment, a method of performing a background firmware update is disclosed comprising booting a device with an original firmware from a first non-volatile memory boot portion, downloading a firmware update during the booting of the device from the non-volatile memory, transmitting the firmware update from the non-volatile memory to the non-volatile memory boot portion so that a successive booting of the device will use the firmware update and erasing the original firmware from the non-volatile memory boot portion.

In another non-limiting embodiment, the method of performing the background firmware update is performed wherein the non-volatile memory boot portion is a NOR memory.

In another non-limiting embodiment, the method may be performed wherein the downloading of the firmware update during the booting of the device from the non-volatile memory is to a second non-volatile memory.

In another non-limiting embodiment, the method of performing the background firmware update may be performed wherein the second non-volatile memory is a NAND flash memory.

In another non-limiting embodiment, the method of performing the background firmware update may be formed wherein the NAND flash memory is a single level cell memory.

In another non-limiting embodiment, the method of performing the background firmware update may be formed wherein the downloading of the firmware update during the booting of the device from the first non-volatile memory is to a second wear leveled non-volatile memory.

In another non-limiting embodiment, the method of performing the background firmware update may further comprise performing a power on procedure for the device prior to the booting the device with the original firmware from the first non-volatile memory boot portion.

In another non-limiting embodiment, the method of performing the background firmware update may be formed wherein the performing a power on procedure for the device prior to the booting the device with the original firmware from the first non-volatile memory boot portion is performed by a controller.

In another non-limiting embodiment, an apparatus is disclosed comprising means for booting a device with an original firmware from a first non-volatile memory boot portion, means for downloading a firmware update during the booting of the device from the non-volatile memory and means for transmitting the firmware update from the non-volatile memory to the non-volatile memory boot portion so that a successive booting of the device will use the firmware update.

In another non-limiting embodiment, the apparatus may further comprise means for erasing the original firmware from the non-volatile memory boot portion.

In another non-limiting embodiment, the apparatus may further comprise means for performing a power on procedure for the device prior to the booting the device with the original firmware from the first non-volatile memory boot portion.

In another non-limiting embodiment, the a method of performing a background firmware update for a solid state device is disclosed comprising: performing a power on procedure for the solid state device, booting the solid state device with an original firmware from a first non-volatile memory boot portion, checking for a firmware update in a second non-volatile memory, downloading a firmware update from the second non-volatile memory, through an interface, during the booting of the solid state device from the non-volatile memory when the checking for the firmware update indicates a presence of the firmware update, transmitting the firmware update from the second non-volatile memory to the first non-volatile memory boot portion so that a successive booting of the device will use the firmware update and erasing the original firmware from the non-volatile memory boot portion.

In another non-limiting embodiment, the method may be performed wherein the first non-volatile memory boot portion is a NOR memory.

In another non-limiting embodiment, the method may be accomplished wherein the second non-volatile memory is a NAND memory.

In another non-limiting embodiment, the method may be accomplished wherein the second non-volatile memory is a single level cell NAND memory.

In another non-limiting embodiment, the method may be accomplished wherein the checking for the firmware update is performed through a controller.

In another non-limiting embodiment, the method may be accomplished wherein the controller has at least one processor.

In another non-limiting embodiment, the method may be accomplished wherein the transmitting of the firmware update from the second non-volatile memory to the first non-volatile memory boot portion so that a successive booting of the device will use the firmware update done in a background environment.

In another non-limiting embodiment, an apparatus for performing a background firmware update is disclosed comprising means for booting the solid state device with an original firmware from a first non-volatile memory boot portion, means for checking for a firmware update in a second non-volatile memory, means for downloading a firmware update from the second non-volatile memory, through an interface, during the booting of the solid state device from the non-volatile memory when the checking for the firmware update indicates a presence of the firmware update, means for transmitting the firmware update from the second non-volatile memory to the first non-volatile memory boot portion so that a successive booting of the device will use the firmware update and means for erasing the original firmware from the non-volatile memory boot portion.

In another non-limiting embodiment, the apparatus may be configured wherein the first non-volatile memory boot portion is a NOR memory.

In another non-limiting embodiment, the apparatus may be configured wherein the second non-volatile memory is a NAND memory.

In another non-limiting embodiment, the apparatus may be configured wherein the second non-volatile memory is a single level cell NAND memory.

In another non-limiting embodiment, the apparatus may be configured wherein the checking for the firmware update is performed through a controller.

In another non-limiting embodiment, the apparatus may be configured wherein the controller has at least one processor.

In another non-limiting embodiment, the apparatus may be configured wherein the transmitting of the firmware update from the second non-volatile memory to the first non-volatile memory boot portion so that a successive booting of the device will use the firmware update done in a background environment.

In another non-limiting embodiment, the apparatus may further comprise means for performing a power on procedure for the solid state device.

In another non-limiting embodiment, an apparatus is disclosed comprising a first non-volatile memory, a second non-volatile memory, an interface configured transmit and receive data from the apparatus and a controller configured to download a firmware update through the interface to the second non-volatile memory, wherein the controller is further configured to copy the firmware from the second non-volatile memory to the first non-volatile memory in a background environment.

In another non-limiting embodiment, the apparatus may be configured wherein the first non-volatile memory is a NOR memory and the second non-volatile memory is a NAND memory.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

While the foregoing is directed to embodiments of the present disclosure, other and further embodiments of the disclosure may be devised without departing from the basic scope thereof, and the scope thereof is determined by the claims that follow.

What is claimed is:

1. A method of performing a background firmware update, comprising:
booting a device with an original firmware from a first memory boot portion;
downloading a firmware update during the booting of the device from the non-volatile memory, the downloading occurring to a non-volatile memory;
transmitting the firmware update from the non-volatile memory to a second boot portion so that a successive booting of the device will use the firmware update; and
erasing the original firmware from the first non-volatile memory boot portion.

2. The method of performing the background firmware update according to claim 1, wherein the first memory boot portion is a NOR memory.

3. The method of performing the background firmware update according to claim 1, wherein the downloading of the firmware update during the booting of the device from the non-volatile memory is to a second non-volatile memory.

4. The method of performing the background firmware update according to claim 3, wherein the second non-volatile memory is a NAND flash memory.

5. The method of performing the background firmware update according to claim 4, wherein the NAND flash memory is a single level cell memory.

6. The method of performing the background firmware update according to claim 1, wherein the downloading of the firmware update during the booting of the device from the first non-volatile memory is to a second wear leveled non-volatile memory.

7. The method of performing the background firmware update according to claim 1, further comprising:
performing a power on procedure for the device prior to the booting the device with the original firmware from the first non-volatile memory boot portion.

8. The method of performing the background firmware update according to claim 7, wherein the performing a power on procedure for the device prior to the booting the device with the original firmware from the first non-volatile memory boot portion is performed by a controller.

9. An apparatus, comprising:
means for booting a device with an original firmware from a first memory boot portion;
means for downloading a firmware update during the booting of the device to the a memory boot portion, the downloading occurring to a non-volatile memory; and
means for transmitting the firmware update from the non-volatile memory to a second boot portion so that a successive booting of the device will use the firmware update.

10. The apparatus according to claim 9, further comprising:
means for erasing the original firmware from the non-volatile memory boot portion.

11. The apparatus according to claim 10, further comprising:
means for performing a power on procedure for the device prior to the booting the device with the original firmware from the first non-volatile memory boot portion.

12. A method of performing a background firmware update for a solid state device, comprising:
performing a power on procedure for the solid state device;
booting the solid state device with an original firmware from a first non-volatile memory boot portion;
checking for a firmware update in a second non-volatile memory;
downloading a firmware update from a second non-volatile memory, through an interface, during the booting of the solid state device from the first non-volatile memory boot portion when the checking for the firmware update indicates a presence of the firmware update;
transmitting the firmware update from the second non-volatile memory to the first non-volatile memory boot portion so that a successive booting of the device will use the firmware update; and
erasing the original firmware from the first non-volatile memory boot portion.

13. The method according to claim 12, wherein the first non-volatile memory boot portion is a NOR memory.

14. The method according to claim 12, wherein the second non-volatile memory is a NAND memory.

15. The method according to claim 14, wherein the second non-volatile memory is a single level cell NAND memory.

16. The method according to claim 14, wherein the checking for the firmware update is performed through a controller.

17. The method according to claim 16, wherein the controller has at least one processor.

18. The method according to claim 14, wherein the transmitting of the firmware update from the second non-volatile memory to the first non-volatile memory boot portion so that a successive booting of the device will use the firmware update done in a background environment.

19. An apparatus for performing a background firmware update, comprising:
means for booting a solid state device with an original firmware from a first non-volatile memory boot portion;
means for checking for a firmware update in a second non-volatile memory;
means for downloading a firmware update from the second non-volatile memory, through an interface, during the booting of the solid state device from the first non-volatile memory when the checking for the firmware update indicates a presence of the firmware update;
means for transmitting the firmware update from the second non-volatile memory to the first non-volatile memory boot portion so that a successive booting of the device will use the firmware update; and
means for erasing the original firmware from the non-volatile memory boot portion.

20. The apparatus according to claim 19, wherein the first non-volatile memory boot portion is a NOR memory.

21. The apparatus according to claim 19, wherein the second non-volatile memory is a NAND memory.

22. The apparatus according to claim 21, wherein the second non-volatile memory is a single level cell NAND memory.

23. The apparatus according to claim 19, wherein the checking for the firmware update is performed through a controller.

24. The apparatus according to claim 23, wherein the controller has at least one processor.

25. The apparatus according to claim 19, wherein the transmitting of the firmware update from the second non-volatile memory to the first non-volatile memory boot portion so that a successive booting of the device will use the firmware update done in a background environment.

26. An apparatus, comprising:
a first non-volatile memory;
a second non-volatile memory;
an interface configured transmit and receive data from the apparatus; and
a controller configured to download a firmware update through the interface to the second non-volatile memory, wherein the controller is further configured to copy the firmware update from the second non-volatile memory to the first non-volatile memory in a background environment.

27. The apparatus according to claim 26, wherein the first non-volatile memory is a NOR memory and the second non-volatile memory is a NAND memory.
